(19) United States
(12) Patent Application Publication
(10) Pub. No.: US 2023/0409800 A1
(43) Pub. Date: Dec. 21, 2023

(54) SYSTEMS AND METHODS FOR CONVERTING ELECTRONIC MESSAGES FROM AN EXTERNALLY SHARED COMMUNICATION CHANNEL IN A GROUP-BASED COMMUNICATION PLATFORM INTO CONVERSATION DATA

(71) Applicant: Capital One Services, LLC, McLean, VA (US)

(72) Inventors: Sara SKEENS, Chesterfield, VA (US); Graham ROLLINS, Glen Allen, VA (US); Pepper Diya TEA, Shirley, NY (US)

(73) Assignee: Capital One Services, LLC, McLean, VA (US)

(21) Appl. No.: 17/807,221

(22) Filed: Jun. 16, 2022

(51) Int. Cl. G06F 40/103

(52) U.S. Cl. CPC G06F 40/103

(57) ABSTRACT

A method of converting electronic messages into conversation data. The method comprises: receiving electronic message data from an externally shared communication channel in a group-based communication platform, wherein the electronic message data comprises: electronic messages; a respective user associated with each electronic message; a respective channel or group associated with each electronic message; and a respective time or date associated with each electronic message; generating a database that represents the electronic message data in a message per row format; generating conversation data by grouping the electronic messages in the database into one or more conversations based on the electronic message data; and outputting the generated conversation data in a form of one or more of: a conversational HTML file; a text file; a CSV file associated with each user associated with each electronic message; or a CSV file associated with each channel or group associated with each electronic message.

### TECHNICAL FIELD

Various embodiments of this disclosure relate generally to electronic message converting techniques for converting electronic messages into conversation data, and, more particularly, to systems and methods for converting electronic messages from multiple sources, including externally shared communication channels in group-based communication platforms, into conversational documents.

### BACKGROUND

In the context of internal investigations, legal compliance, and trial litigation, corporate entities are often required to obtain and review different data types obtained from multiple different data sources. Due to this variety of data, it is often difficult for investigators and litigation teams to review this variety of data due to the lack of a standardized format for analysis. In the case of data sources with different structured formats (e.g., instant messaging, chat, mobile text messaging), determining the conversational context and finding ways to integrate this data with other data types (e.g., electronic mail, documents) is challenging. For example, there exist shared communication channels in group-based communication platforms (such as Slack® and Microsoft® Teams) that further contain data that is difficult to analyze and export. While APIs exist for extraction of some data from such group-based communication platforms, when a particular matter requires data from such platforms and other platforms and sources, it is difficult to collect, convert, and display that data in a way that is meaningful for analysis and review across multiple litigation and investigation discovery tools. Further, data obtained from these sources is often not easily reviewed outside of a traditional eDiscovery review platform (e.g., Relativity®). Thus, entities are currently limited in the ability to produce information in a way that is both easy to understand and review while also being processable by standard document processing techniques such as imagining and Bates numbering. Additionally, data from these sources is often not compatible with different types of text analytics tools, including machine learning and natural language processing, due to the lack of conversational context. It is further challenging for reviewers to determine the context of a conversation when looking at individual lines or messages. Conventional techniques, including the foregoing, fail to provide conversational documents that are simpler and easier to analyze, especially outside of traditional E-discovery platforms such as Relativity®.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for converting electronic messages into conversation data. In one aspect, an exemplary embodiment of a method for converting electronic messages into conversation data may include: receiving, via an Application Programming Interface (API), electronic message data from an externally shared communication channel in a group-based communication platform, wherein the electronic message data comprises: a plurality of electronic messages; a respective user associated with each electronic message of the plurality of electronic messages; a respective channel or group associated with each electronic message; and a respective time or date associated with each electronic message; generating, by the one or more processors, a database that represents the electronic message data in a message per row format; generating conversation data by grouping the electronic messages in the database into one or more conversations based on the electronic message data; and outputting the generated conversation data in a form of one or more of: a conversational HTML file; a text file; a CSV file associated with each user associated with each electronic message; a CSV file containing each electronic message and respective metadata associated with each electronic message; or a CSV file associated with each channel or group associated with each electronic message.

In another aspect, an exemplary embodiment of a method for using a trained machine-learning model for converting electronic messages into conversation data may include: receiving, via an Application Programming Interface (API), electronic message data from an externally shared communication channel in a group-based communication platform, wherein the electronic message data comprises: a plurality of electronic messages; a respective user associated with each electronic message of the plurality of electronic messages; a respective channel or group associated with each electronic message; and a respective time or date associated with each electronic message; receiving electronic text message data from an instant electronic text messaging application separate from the externally shared communication channel in the group-based communication platform; generating a database that represents the electronic message data and the electronic text message data on a database in a message per row format; generating conversation data by grouping, using a trained machine learning model, the electronic messages and electronic text messages in the database together into one or more conversations based on the electronic message data and electronic text message data, wherein the trained machine learning model has been trained based on (i) training electronic message data and electronic text message data that includes information regarding one or more electronic messages associated with the electronic message data and one or more electronic text messages associated with the electronic text message data and (ii) training conversation data that includes a prior category for each of the one or more electronic messages and the one or more electronic text messages, to learn relationships between the training electronic message data and text message data and the training conversation data, such that the trained machine learning model is configured to use the learned relationships to determine a conversation for an electronic message or electronic text message in response to input of data related to the electronic message or electronic text message; and outputting the generated conversation data in a form of one or more of: a conversational HTML file; a text file; a CSV file associated with each user associated with each electronic message; or a CSV file associated with each channel or group associated with each electronic message.

In a further aspect, an exemplary embodiment of a system for converting electronic messages into conversation data may include: a memory storing instructions; and a processor operatively connected to the memory and configured to execute the instruction to perform operations. The operations may include: receiving, via an Application Programming Interface (API), electronic message data from an externally shared communication channel in a group-based communication platform, wherein the electronic message data comprises: a plurality of electronic messages; a respective user associated with each electronic message of the plurality of electronic messages; a respective channel or group associated with each electronic message; and a respective time or date associated with each electronic message; generating a database that represents the electronic message data in a message per row format; generating conversation data by grouping, using a trained machine learning model, the electronic messages in the database into one or more conversations based on the electronic message data, wherein the trained machine learning model is trained based on (i) training electronic message data that includes information regarding one or more electronic messages associated with the electronic message data and (ii) training conversation data that includes a prior category for each of the one or more electronic messages, to learn relationships between the training electronic message data and the training conversation data, such that the trained machine learning model is configured to use the learned relationships to determine a conversation for an electronic message in response to input of data related to the electronic message; and outputting the generated conversation data in a form of one or more of: a conversational HTML file; a text file; a CSV file associated with each user associated with each electronic message; or a CSV file associated with each channel or group associated with each electronic message.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for converting electronic messages into conversation data via a message conversion engine, according to one or more embodiments.

FIG. 2 depicts a block diagram for converting electronic messages into conversation data, according to one or more embodiments.

FIG. 3. depicts a flowchart of an exemplary method of using a message conversion engine to convert electronic messages into conversation data, according to one or more embodiments.

FIG. 4 depicts a flowchart of another exemplary method of using a trained machine-learning model to convert electronic messages into conversation data, according to one or more embodiments.

FIG. 5 depicts an example of a computing device, according to one or more embodiments.

### DETAILED DESCRIPTION OF EMBODIMENTS

According to certain aspects of the disclosure, methods and systems are disclosed for converting electronic messages into conversation data, e.g., generating a database that represents electronic messages in a data-per-row format, grouping the messages into conversations, and outputting the conversations into a conversational HTML file. Electronic messages may comprise natural language text, emojis, documents, audio or visual files, or other communications. There is a need to acquire and export data for analysis from different types of electronic message databases, especially in the context of internal investigations and trial litigation. However, conventional techniques may not be suitable. For example, conventional techniques generate standardized, cross platform, and/or standalone capable HTML documents centered around specific conversations from databases containing Slack® channel messages, phone text messages, and other types of electronic messages. Accordingly, improvements in technology relating to converting electronic messages into conversation data are needed.

As will be discussed in more detail below, in various embodiments, systems and methods are described for using machine learning to convert electronic messages of various formats into conversation data. For example, messages from different sources such as cell phone text messages, instant messaging applications, and shared group-based communication platforms may be all formatted into the same standardized conversational documents. By training a machine-learning model, e.g., via supervised or semi-supervised learning, to learn associations between message data such as electronic message data that includes information regarding one or more electronic messages and training data such as training conversation data that includes a prior category for each of the one or more electronic messages, the trained machine-learning model may be usable to determine a respective conversation for each electronic message in response to input of the plurality of electronic messages and data related to the plurality of electronic messages in order to output one or more of: a conversational HTML file, a text file, a CSV file associated with each user associated with each electronic message, a CSV file containing each electronic message and respective metadata associated with each electronic message, or a CSV file associated with each channel or group associated with each electronic message. This results in a technical improvement, including an improved means for converting and formatting electronic messages in a manner that is faster and easier than prior traditional technical document formats. Additionally, converting and formatting electronic messages according to the methods of this disclosure results in reduced computing resources (e.g., processing and storage) as the electronic messages are stored in a consolidated manner which avoids duplicative data processing and storage, and enables more efficient use of human resources (e.g., time) to identify various conversations and review such conversations for a particular need.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The term “browser extension” may be used interchangeably with other terms like “program,” “electronic application,” or the like, and generally encompasses software that is configured to interact with, modify, override, supplement, or operate in conjunction with other software. As used herein, terms such as “script” or the like generally encompass a list of commands that are executed by a program or scripting engine to perform function, for example, collecting data from a shared communication channel or converting data into a different format.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

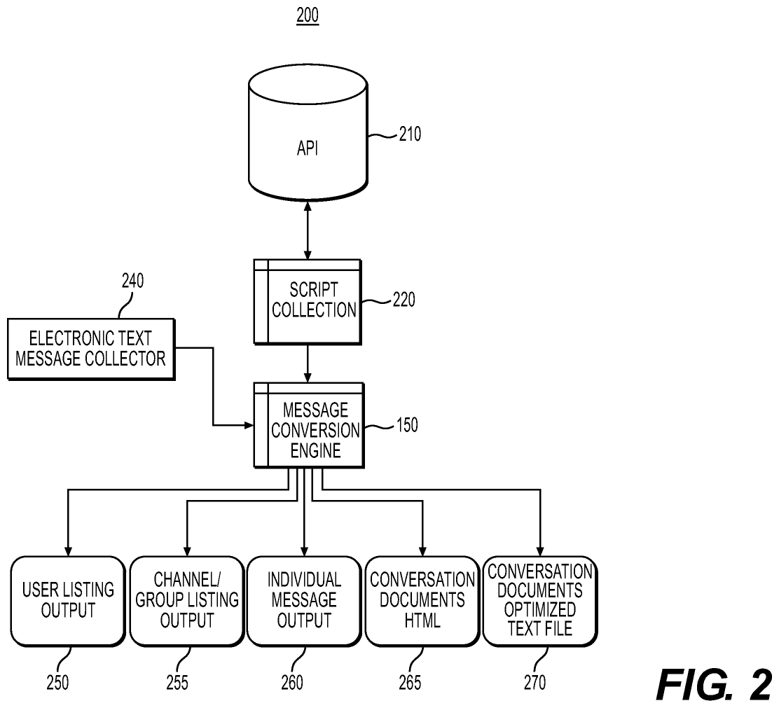

In an exemplary use case, a message conversion engine may be used to convert multiple forms of structured electronic messages into conversation data (e.g., a single html document reflecting a single conversation between two or more participants). For example, electronic messages and corresponding data may be extracted from a Slack® API using a python script, as explained below with respect to FIG. 2. Electronic text messages and corresponding data from one or more user phones may also be received. Both electronic messages and electronic text messages may comprise natural language text, emojis, documents, audio or visual files, or other communications. The message conversion engine may then use one or more conversion scripts to format the data (e.g., the data extracted from the Slack® API and the data received relating to electronic text messages) into a message per row format and then group the messages into conversations based on factors described herein such as conversation participants and/or time delay between messages. The message conversion engine may then generate, for example, a conversational HTML document for each conversation that is viewable and without the need of an e-discovery tool (e.g., Relativity®) and with the capability to be utilized in multiple different e-Discovery tools. A supervised, unsupervised, and/or topical machine-learning model may be used to determine a respective conversation for each electronic message and electronic text message in response to input of the electronic messages and electronic text messages and data related to the electronic messages and electronic text messages, where the machine-learning model is trained based on prior conversation categories for each of the one or more electronic messages and electronic text messages. While a supervised model may be described herein as exemplary, unsupervised and/or topic modeling are also within the scope of this disclosure. While Slack® and Python are used as exemplary here, as explained below, other group-based communication platforms (e.g., Microsoft® Teams) or other appropriate programming language (e.g., JavaScript, Ruby, C, Nim, and so forth) are contemplated here.

In another exemplary use case, a message conversion engine may be used to convert multiple forms of structured electronic messages into conversation data (e.g., a single html document reflecting a single conversation between two or more participants) using an unsupervised trained machine learning model. As in the above case, electronic messages and corresponding data may be extracted from a Slack® API using a python script, and electronic text messages and corresponding data from one or more user phones may also be received. The message conversion engine may then, as explained above, use one or more conversion scripts to format the data into a message per row format and then group the messages into conversations based on factors described herein such as conversation participants and/or time delay between messages. The message conversion engine may then generate, for example, a conversational HTML document for each conversation that is viewable and without the need of an e-discovery tool and with the capability to be utilized in multiple different e-Discovery tools. An unsupervised trained machine-learning model may be used to determine a respective conversation for each electronic message and electronic text message in response to input of the electronic messages and electronic text messages and data related to the electronic messages and electronic text messages (e.g., data obtained from natural language processing, metadata from time, program or application used, and so forth). The unsupervised trained machine-learning model may perform a clustering operation on all of the messages to generate clusters, where each cluster corresponds to a conversation. A conversational document for each cluster may then be output as described above and further below.

While the example above involves electronic messages and text messages, it should be understood that techniques according to this disclosure may be adapted to any suitable type of data with varying structure types. It should also be understood that the examples above are illustrative only. The techniques and technologies of this disclosure may be adapted to any suitable activity.

Presented below are various aspects of machine learning techniques that may be adapted to convert electronic messages into conversation data. As will be discussed in more detail below, machine learning techniques adapted to determine a respective conversation for messages stored on a database in response to input of the messages and data related to the messages, may include one or more aspects according to this disclosure. For example, this disclosure contemplates a particular selection of training data, a particular training process for the machine-learning model, operation of a particular device suitable for use with the trained machine-learning model, operation of the machine-learning model in conjunction with particular data, modification of such particular data by the machine-learning model, etc., and/or other aspects that may be apparent to one of ordinary skill in the art based on this disclosure.

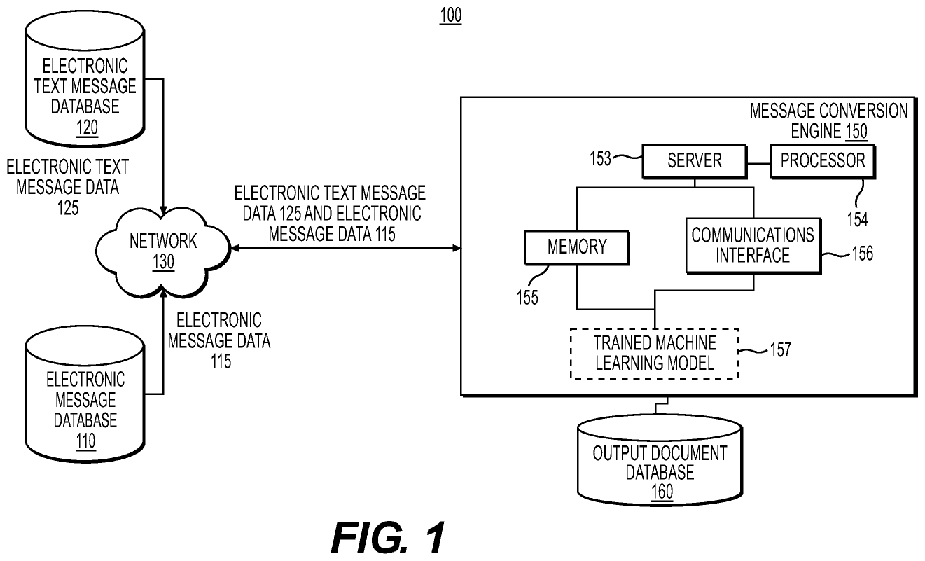

FIG. 1 depicts an exemplary environment (e.g., environment 100) that may be utilized with techniques presented herein. The environment 100 may include a group-based communication platform database 110 and an electronic text message database 120 which may communicate across an electronic network 130. The group-based communication platform database 110 may be, for example, a database associated with a group-based communication platform such as, but not limited to, Slack®, Microsoft® Teams, Discord®, and so forth. The electronic text message database 120 may be, for example, a database associated with instant messaging messages and/or cell phone text messages. As will be discussed in further detail below, a message conversion engine 150 may communicate with one or more of the other components of the environment 100 across electronic network 130.

In some embodiments, the components of environment 100 are associated with a common entity, e.g., a financial institution, transaction processor, merchant, enterprise, business, or the like. In some embodiments, one or more components of environment 100 is associated with a different entity than one or more other components of environment 100. The systems and devices of the environment 100 may communicate in any arrangement. As will be discussed herein, systems and/or devices of environment 100 may communicate in order to one or more of generate, train, or use a machine-learning model to convert electronic messages into conversation data, among other activities.

The message conversion engine 150 may be configured to allow a user to access and/or interact with other systems in the environment 100. For example, the message conversion engine 150 may be a computer system such as, for example, a desktop computer, a mobile device, a tablet, etc. In some embodiments, the message conversion engine 150 may include one or more electronic application(s), e.g., a program, plugin, browser extension, etc., installed on a memory of the message conversion engine 150. In some embodiments, the electronic application(s) may be associated with one or more of the other components in the environment 100. For example, the electronic application(s) may include one or more of system control software, system monitoring software, software development tools, etc.

The group-based communication platform database 110, the electronic text message database 120, or the message conversion engine 150 may each be associated with a server system, an electronic data system, and computer-readable memory such as a hard drive, flash drive, disk, etc. For example, as shown in FIG. 1, the message conversion engine 150 may comprise a server 153, a processor 154, memory 155, communications interface 156, and a trained machine learning model 157. The message conversion engine 150 may further be in communication with an output document database 160, which may include one or more repositories of information, as will be described in further detail below. In some embodiments, the group-based communication platform database 110, electronic text message database 120, or the message conversion engine 150 includes and/or interacts with an application programming interface for exchanging data to other systems, e.g., one or more of the other components of the environment. The group-based communication platform database 110, the electronic text message database 120, or the message conversion engine 150 may include and/or act as a repository or source for message data, for example, electronic message data 115 and/or electronic text message data 125, as discussed in more detail below.

In various embodiments, the electronic network 130 may be a wide area network (“WAN”), a local area network (“LAN”), personal area network (“PAN”), or the like. In some embodiments, electronic network 130 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

As discussed in further detail below, the message conversion engine 150 may be in communication with, or in some embodiments contain, a trained machine learning model 157. The message conversion engine 150 may one or more of (i) generate, store, train, or use a machine-learning model, such as trained machine learning model 157, configured to group the electronic messages into one or more conversations. The message conversion engine 150 may include a machine-learning model and/or instructions associated with the machine-learning model, e.g., instructions for generating a machine-learning model, training the machine-learning model, using the machine-learning model, etc. The message conversion engine 150, trained machine learning model 157, or other component may include instructions for retrieving electronic message data and adjusting electronic message data, e.g., based on the output of the machine-learning model. The message conversion engine 150, trained machine learning model 157, or other component may include training data, e.g., electronic message data that includes information regarding one or more electronic messages associated with the training electronic message data, and may include ground truth, e.g., training conversation data that includes a prior category for each of the one or more electronic messages data.

In some embodiments, a system or device other than the message conversion engine 150 is used to generate and/or train the machine-learning model. For example, such a system may include instructions for generating the machine-learning model, the training data and ground truth, and/or instructions for training the machine-learning model. A resulting trained-machine-learning model may then be provided to the message conversion engine 150.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between electronic message data that includes information regarding one or more electronic messages associated with the training electronic message data and training conversation data that includes a prior category for each of the one or more electronic messages data, such that the trained machine-learning model is configured to determine an output a respective conversation for each electronic message in response to the input electronic messages data based on the learned associations.

In various embodiments, the variables of a machine-learning model may be interrelated in any suitable arrangement in order to generate the output. In some instances, different samples of training data and/or input data may not be independent. Thus, in some embodiments, the machine-learning model may be configured to account for and/or determine relationships between multiple samples. For example, in some embodiments, the machine-learning model associated with the message conversion engine 150 may include a Recurrent Neural Network (“RNN”). Generally, RNNs are a class of feed-forward neural networks that may be well adapted to processing a sequence of inputs. In some embodiments, the machine-learning model may include a Long Short Term Memory (“LSTM”) model and/or Sequence to Sequence (“Seq2Seq”) model. An LSTM model may be configured to generate an output from a sample that takes at least some previous samples and/or outputs into account.

Although depicted as separate components in FIG. 1, it should be understood that a component or portion of a component in the environment 100 may, in some embodiments, be integrated with or incorporated into one or more other components. For example, the message conversion engine 150 may be integrated with the electronic text message database 120 or the group-based communication platform database 110 or the like. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized for converting electronic messages into conversation data are discussed in further detail in the methods below. In the following methods, various acts may be described as performed or executed by a component from FIG. 1, such as the message conversion engine 150 or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

FIG. 2 depicts a block diagram of an exemplary data flow (e.g. data flow 200) that may be utilized with techniques presented herein. With respect to the data flow 200, an API 210 for a shared communication channel such as the group-based communication platform (e.g., Slack®) associated with the group-based communication platform database 110 may provide, or be used to retrieve, electronic message data 115. The electronic message data 115 may be provided to, or retrieved via, script collection 220. Script collection 220 may comprise a list of commands written in a programming language (e.g., python) that is executed by a program or scripting engine to collect data from a group-based communication platform, such as Slack®. Accordingly, the script collection 220 may collect, via API 210, electronic message data 115. For example, electronic message data 115 including alphanumeric text, emojis, or other characters, a respective user associated with each electronic message, a channel or group associated with each electronic message, documents, audio or visual files, and/or time and date associated with each electronic message may be collected. It is understood that in some embodiments, script collection 220 may collect electronic message data 115 without the use of the API 210. Additionally, it is understood that API 210 is depicted in FIG. 2 as a single API, script collection 220 may collect electronic message data 115 from multiple sources via multiple APIs (e.g., each API being associated with a different group-based communication platform). Still further, it is understood that in some arrangements, script collection 220 may collect electronic message data 115 from various sources, including one or more sources via API 210 and one or more sources without the use of an API 210.

In some embodiments, electronic text message data 125 may be provided by or retrieved from electronic text message database 120 (FIG. 1) via electronic text message collector 240. Additionally, or alternatively, electronic text message data 125 may be provided by or retrieved directly from a text messaging platform without prior storage in electronic text message database 120. In some embodiments, electronic text message collector 240 may utilize an API of a text messaging platform, or alternatively, may export electronic text message data 125 from a native application of the text messaging platform. For example, in some embodiments, electronic text message data 125 may be data obtained from a user's cellphone or cellular service company via an API or another method, and might comprise text messages stored on the user's cellphone or by the cellular service. The electronic text message data 125 in some embodiments may be obtained by the message conversion engine 150 separately from the script collection 220. While python is the programming language used herein by example, other suitable programming languages may be implemented (e.g., JavaScript, Ruby, C, Nim, and so forth).

The message conversion engine 150, may receive electronic message data 115 and electronic text message data 125. For example, electronic message data 115 and electronic text message data 125 may be collected/retrieved in the manner described above. Upon collection/retrieval, the message conversion engine 150 may convert (e.g., format) the electronic message data 115 and/or electronic text message data 125 into one or more possible outputs, as described further below. In some embodiments, the message conversion engine 150 may generate a database (e.g., a first database) that represents the electronic message data 115 in a message-per-row format, such that each row in the database represents a different electronic message. In some embodiments, the message conversion engine 150 may generate an additional database (e.g., a second database) that represents the electronic text message in a message-per-row format, such that each row in the database represents a different electronic text message.

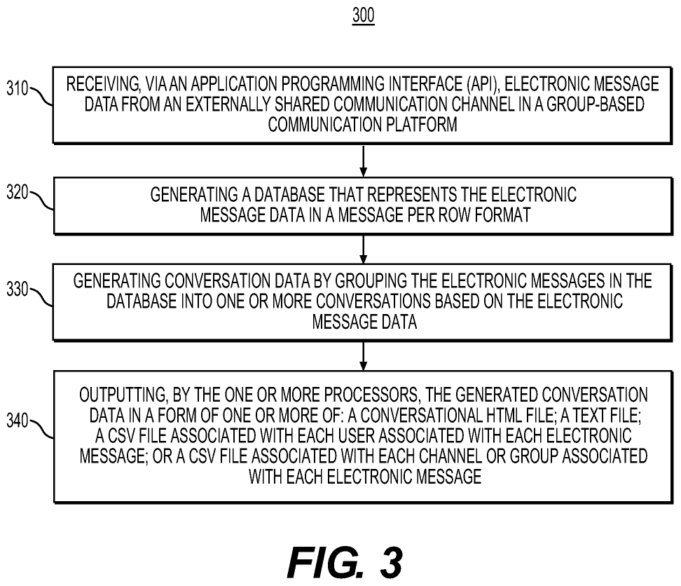

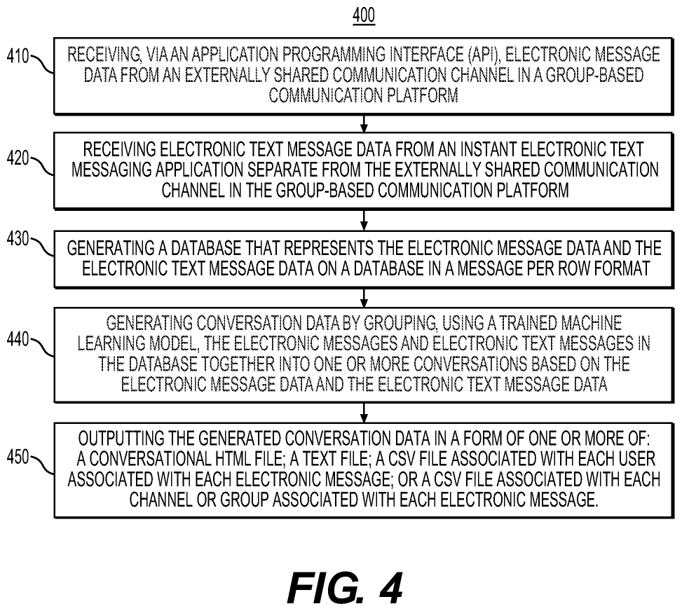

Then, conversation data is generated based on the first database and/or the second database, as described further below with respect to FIGS. 3-4. For example, the message conversion engine 150 may group the electronic messages into categories (e.g., conversations) based on the electronic message data 115. For example, the message conversion engine 150 may determine that a subset of the electronic messages fall into the same “conversation” based on participant information (e.g., senders and receivers of the electronic messages), subject matter, time and dates of the messages, or other factors, and then group that subset into a conversation. In some embodiments, the conversation groups are further determined based on a timeframe criteria, for example, a time delay between messages. For example, there may be ongoing messages on a shared communication channel between the same participants over an extended period of time (e.g., days or weeks). A time delay threshold of 30 minutes may be used for purposes of generating conversations. Thus, when the message conversion engine 150 groups the messages between the participants into conversations, any messages or group of messages that are sent more than 30 minutes apart are deemed separate conversations, and grouped separately from each other. While 30 minutes is used here as exemplary, other time frame criteria may also work depending on the types and nature of the conversations (e.g., seconds, minutes, hours, days, or weeks). In some cases, multiple timeframe criteria may be applied to different participants or different data sets. For example, electronic messages between participants A and B might have a time frame criteria or delay of 45 seconds, while messages between participants C and D might have a time frame criteria or delay of 2 hours. In this manner, electronic messages may be more accurately grouped into conversations for easier and more efficient review and processing.

In some embodiments, messages may be grouped by the message conversion engine 150 based on context using natural language processing. For example, via natural language processing, certain words or phrases may be recognized, and then messages containing those words or phrases may be clustered together and/or grouped into conversations. In an exemplary use case, a unique word or phrase may be a project name (e.g., “project turbo”). The message conversion engine 150 may then determine that messages including the phrase “project turbo” are more likely to be part of the same conversation. According to further aspects of this disclosure, unsupervised learning techniques and/or topic modeling based on metadata (e.g., timestamps, participants) may be used to extract the information and then determine the relationships between the messages, as well as further refine groupings logically based on the metadata. Thus, the message conversion engine 150 is able to more accurately group messages into conversation using context via natural language processing.

As further shown in FIG. 2, the outputs of the message conversion engine 150 may be, for example, a user listing output 250, a channel/group listing output 255, an individual message output 260, a conversation documents HTML 265, and/or a conversation documents optimized text file 270. The user listing output 250 may be, for example, a .csv file containing a list of all users associated with electronic messages in the electronic message data 115 and/or electronic text messages in electronic text message data 125. The user listing output 250 may be, for example, a .csv file containing a list of all users associated with electronic messages in the electronic message data 115 and/or electronic text messages in electronic text message data 125. The channel/group listing output 255 may be, for example, a .csv file containing a list of all channel and/or groups associated with electronic messages in the electronic message data 115 and/or electronic text messages in electronic text message data 125. Similarly, individual message output 260 may be, for example, a .csv file containing all the electronic messages in the electronic message data 115 and/or electronic text messages in electronic text message data 125. The conversation documents HTML 265 may be, for example, an html document that presents the electronic messages grouped into a conversation in a native format. For example, where the electronic message data 115 is data obtained from group-based communication platform database 110, the conversation documents HTML 265 may present a conversation grouped by the message conversion engine 150 into a format that looks similar (e.g., similar in format/layout) to how messages were natively presented in group-based communication platform database 110. Similarly, the conversation documents HTML 265 may also present a conversation generated based on electronic text message data 125 into its native format, which might be an Apple® or Android® text messaging application. The conversations documents optimized text file 270 may be a .text file corresponding to a conversation, but with metadata information removed in order to optimize the file for use in text analytics and/or natural language process (NLP). In this manner, the outputs of the message conversion engine 150 allow for message data to be reviewed and processed easily without a traditional E-discovery platform, while at the same time are also compatible with traditional E-discovery platforms and analytics. In some embodiments, a unique numbering format may also be utilized for messages that allowed for easy identification of duplicate messages within the electronic message data 115 or electronic text message data 125. In some embodiments, the message conversion engine 150 may be modifiable. For example, the message conversion engine 150 can be modified to generate conversation documents based on different parameters, for example, date range, custodian, channel ranges, or other user defined parameters.

FIG. 3 illustrates an exemplary process (e.g., process 300) of using a message conversion engine 150 to convert electronic messages into conversation data. At step 310 of the process 300, the message conversion engine 150 may receive, via an Application Programming Interface (API) such as API 210, electronic message data 115 from an externally shared communication channel in a group-based communication platform (e.g., Slack®). The electronic message data 115 may comprise, for example, a plurality of electronic messages, a respective user or participant associated with each electronic message of the plurality of electronic messages, a respective channel or group associated with each electronic message, and a respective time or date associated with each electronic message. The electronic messages may comprise natural language text, emojis, documents, audio or visual files, or other communications. The electronic message data 115 may comprise additional information or metadata. Such metadata may include additional information related to the message, for example, file size, versions, links to other messages or websites, viewing history (e.g., collection of users who received and/or viewed the electronic message), or other information that may be relevant to understanding the messages.

As noted above, the electronic message data 115 may include a respective user(s)/participant(s) associated with each electronic message. For example, a user or participant may be associated with an electronic message if the user or participant (or group thereof) authored, edited, received, or viewed one or more electronic messages of the plurality of electronic messages. A respective channel or group associated with each electronic message may also be associated with each electronic message. For example, in some group-based communication platforms, messages are shared in specific areas known as “groups” or “channels” such that access is limited to specific participants in these groups or channels. Further, a history of messages sent in that channel may be stored in that channel or group for a predetermined time, and members of the channel or group may receive indications or notifications whenever a participant enters an electronic message in the channel or group. In some embodiments, the electronic message data 115 may further comprise edit history information associated with each electronic message. Some platforms, such as Slack®, may allow a user to modify, edit, or delete a previously sent message. These edits or changes may be tracked or recorded as edit history information, and may further be relevant to a business or enterprise. Accordingly, these tracked edits may also be grouped into conversations according to aspects of the disclosure.

In some embodiments, the message conversion engine 150 may also receive, via electronic text message collector 240, electronic text message data 125 from an electronic text message database 120 separate from the group-based communication platform database 110. The electronic text message data 125 may comprise a plurality of electronic text messages, a respective sender associated with each electronic text message of the plurality of text messages, one or more respective recipients associated with each electronic text message, and a respective time or date associated with each electronic text message. In some embodiments, the instant electronic text messaging application is implemented on a mobile device and the electronic text message data 125 is received from an electronic text message database 120 associated with the mobile device. The electronic text messages may comprise natural language text, emojis, documents, audio or visual files, or other communications. Electronic text message data 125 may additionally comprise additional relevant metadata and information, for example, a cellular phone number or an email address associated with a user account.

At step 320, the message conversion engine 150 may generate a database (e.g., a first database) that represents the electronic message data in a message per row format. For example, as described above with respect to FIG. 2, the message conversion engine 150 may generate a comma separated value (CSV or .csv) file. Each row of the CSV file may store one message and, in some cases, corresponding data and metadata. A CSV is a type of simple text based file, with each line of a CSV file typically containing the same sequence of data in order to be easily read by a program or software, and typically include delimiters to separate pieces of information within the document (e.g., semicolons, spaces, commas, or some other character for separating information). In some embodiments, a unique sequence value may be generated for each electronic message stored on the database based on respective metadata associated with each electronic message. In some embodiments, the message conversion engine 150 may determine whether an electronic message stored on the database is a duplicate message based on the unique sequence value, and upon determining that an electronic message is a duplicate message, may automatically remove the duplicate message from the database. In some embodiments, the unique sequence value may be a hash value that is generated in response to a hash function or algorithm. The unique sequence value may further be a short code or symbol that represents the electronic message stored on the database. While a .csv or CSV file is used as exemplary here, other document format types, such as DAT, Microsoft® Excel, Google® Sheets, or other structured file formats, are within the scope of this disclosure. In some embodiments, as described above, the message conversion engine 150 may generate an additional database (e.g., a second database) that represents the electronic text message data in a message per row format as described above.

At step 330, the message conversion engine 150 may generate conversation data by grouping the electronic messages in the database (e.g., first database at step 320) into one or more conversations based on the electronic message data, previously described above with respect to FIG. 2. For example, the message conversion engine 150 may determine conversations based on the electronic message data 115 and corresponding participants, content, metadata, and/or a timeframe criteria. For example, the message conversion engine 150 may determine that electronic messages exchanged between participant A and participant B in a channel Y during a specific timeframe (e.g., between noon and 2 pm on Jan. 1, 2020) are a conversation, and generate conversation data accordingly. In some embodiments, the grouping the electronic messages into one or more conversations further comprises grouping, by the one or more processors, the electronic messages in the first database and the electronic text messages in the additional database (e.g. second database) together into one or more conversations. In some embodiments, the grouping of the electronic messages into one or more conversations is further based on a time frame criteria. In additional embodiments, the time frame criteria may be an inactivity time or an amount of time that has lapsed between electronic messages, for example, 15 minutes. As an example, if participant A and participant B in a channel Y exchange multiple messages over a span of multiple days, the messages may be separated into conversations based on the lapse in time between messages (e.g., when 15 or more minutes pass between messages, the later messages may be grouped into a conversation separate from the earlier messages). The message conversion engine 150 in some embodiments may further generate conversation data based on the subject matter of messages. For example, messages exchanged between participant A and participant B may have been exchanged in different platforms (for example, both on Slack® and via iMessage) or on different Slack® channels, but the subject matter may relate to the same subject (e.g., a specific product design). The message conversion engine 150 may determine that these messages, while exchanged on different platforms or channels, are part of the same conversation, and accordingly, may be included in the same conversational document.

In some embodiments, grouping the electronic messages into one or more conversations further includes using a trained machine learning model, wherein the trained machine learning model has been trained based on (i) training electronic message data that includes information regarding one or more electronic messages associated with the training electronic message data and (ii) training conversation data that includes a prior category for each of the one or more electronic messages, to learn relationships between the training electronic message data and the training conversation data, such that the trained machine learning model is configured to use the learned relationships to determine a respective conversation for each electronic message in response to input of the plurality of electronic messages and data related to the plurality of electronic messages. According to aspects of the disclosure, an unsupervised machine learning model bay be used. For example, the message conversion engine 150 may group the electronic messages by representing each of the plurality of electronic messages as one or more features, the one or more features at least including a time frame associated with each message. The message conversion engine 150, via the unsupervised machine learning model, may then perform a clustering operation on the plurality of electronic messages based on the one or more features to identify one or more clusters of messages corresponding to one or more conversations. According to some aspects, the conversation data for each conversation may include electronic messages from a corresponding cluster.

At step 340, the message conversion engine 150 may output the conversation data generated at step 330 in the form of one or more of: a conversational HTML file, a text file, a CSV file associated with each user associated with each electronic message, or a CSV file associated with each channel or group associated with each electronic message. These outputs are described above with respect to FIG. 2. In some embodiments, the conversational HTML file, the conversational text file, the CSV file associated with each user, or the CSV file associated with each channel or group, are viewable and editable using standard word processing software. While CSV files are discussed here, other structured file formats, such as DAT files, are within the scope of this aspect of the disclosure. In some embodiments, the outputs of step 340 may be cleaned of any metadata, which further allows for better machine learning or natural language processing to the documents.

FIG. 4 illustrates an exemplary process 400 for converting electronic messages into conversation data, e.g., by utilizing a trained machine-learning model such as a trained machine learning model 157, discussed above. At step 410 of the process 400, the message conversion engine 150 may receive via an Application Programming Interface (API), electronic message data 115 from an externally shared communication channel in a group-based communication platform, as described above with respect to step 310 of FIG. 3.

At step 420, the message conversion engine 150 may receive electronic text message data 125 from an instant electronic text messaging application separate from the externally shared communication channel in the group-based communication platform, as described above with respect to step 310 of FIG. 3. Electronic text message data 125 may include, for example short message service (SMS) data or iMessage data obtained from a mobile or portable device.

At step 430, the message conversion engine 150 may generate a database that represents both the electronic message data 115 and the electronic text message data 125 on a database in a message per row format, similar to what was described above with respect to step 320 of FIG. 3. Instead of generating a first database for electronic message data 115 and a second database for electronic text message data 125, a single consolidated database is instead generated that contains both types of messages (e.g., electronic messages and electronic text messages) on a single database.

At step 440, the message conversion engine 150 may generate conversation data by grouping, using a trained machine learning model, the electronic messages and electronic text messages in the database together into one or more conversations based on the electronic message data 115 and electronic text message data 125, as described above with respect to step 330 of FIG. 3.

At step 450, the message conversion engine 150 may output the generated conversation data in a form of one or more of: a conversational HTML file, a text file, a CSV file associated with each user associated with each electronic message, or a CSV file associated with each channel or group associated with each electronic message, as described above with respect to step 340 of FIG. 3.

As explained previously, aspects of this disclosure result in a technical improvement, including an improved means for converting and formatting electronic messages in a manner that is faster and easier than prior traditional technical document formats. Additionally, converting and formatting electronic messages according to the methods of this disclosure results in reduced computing resources (e.g., processing and storage) as the electronic messages are stored in a consolidated manner which avoids duplicative data processing and storage, and enables more efficient use of human resources (e.g., time) to identify various conversations and review such conversations for a particular need. Further, the files generated above may be used as stand-alone files for analysis or may be easily be output into a multitude of platforms, resulting in further technical improvements. It should be understood that embodiments in this disclosure are exemplary only, and that other embodiments may include various combinations of features from other embodiments, as well as additional or fewer features. For example, while some of the embodiments above pertain to converting electronic messages into conversation data, any suitable activity may be used.

In general, any process or operation discussed in this disclosure that is understood to be computer-implementable, such as the processes illustrated in FIGS. 3 and 4, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

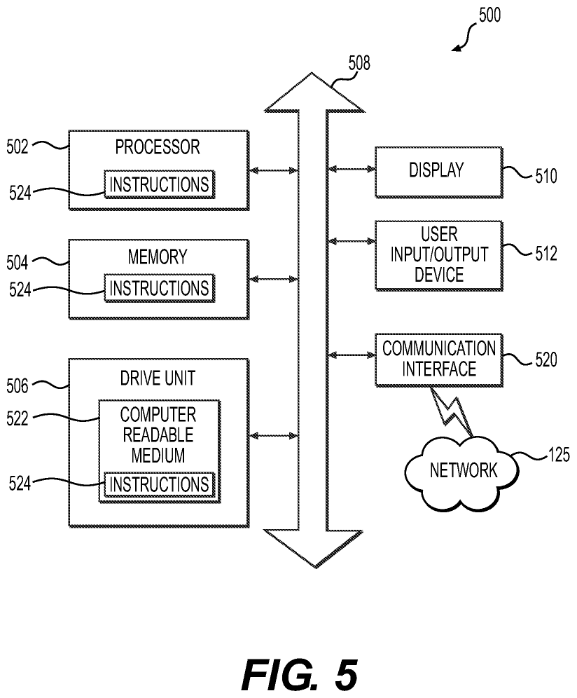

FIG. 5 is a simplified functional block diagram of a computer 500 that may be configured as a device for executing the methods of FIGS. 3 and 4, according to exemplary embodiments of the present disclosure. For example, the computer 500 may be configured as the message conversion engine 150 and/or another system according to exemplary embodiments of this disclosure. In various embodiments, any of the systems herein may be a computer 500 including, for example, a data communication interface 520 for packet data communication. The computer 500 also may include a central processing unit (“CPU”) 502, in the form of one or more processors, for executing program instructions. The computer 500 may include an internal communication bus 508, and a storage unit 506 (such as ROM, HDD, SDD, etc.) that may store data on a computer readable medium 522, although the computer 500 may receive programming and data via network communications. The computer 500 may also have a memory 504 (such as RAM) storing instructions 524 for executing techniques presented herein, although the instructions 524 may be stored temporarily or permanently within other modules of computer 500 (e.g., processor 502 and/or computer readable medium 522). The computer 500 also may include input and output ports 512 and/or a display 510 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for converting electronic messages into conversation data, the method comprising:
receiving, by one or more processors and via an Application Programming Interface (API), electronic message data from an externally shared communication channel in a group-based communication platform, wherein the electronic message data comprises:
a plurality of electronic messages;
a respective user associated with each electronic message of the plurality of electronic messages;
a respective channel or group associated with each electronic message; and
a respective time or date associated with each electronic message;
generating, by the one or more processors, a database that represents the electronic message data in a message per row format;
generating conversation data by grouping, by the one or more processors, the electronic messages in the database into one or more conversations based on the electronic message data; and
outputting, by the one or more processors, the generated conversation data in a form of one or more of:
a conversational HTML file;
a text file;
a CSV file containing each electronic message and respective metadata associated with each electronic message;
a CSV file associated with each user associated with each electronic message; or
a CSV file associated with each channel or group associated with each electronic message.

2. The computer-implemented method of claim 1, further comprising:
receiving, by one or more processors, electronic text message data from an instant electronic text messaging application separate from the externally shared communication channel in the group-based communication platform, wherein the electronic text message data comprises:
a plurality of electronic text messages;
a respective user associated with each electronic text message of the plurality of electronic text messages;
one or more respective recipients associated with each electronic text message; and
a respective time or date associated with each electronic text message;
generating, by the one or more processors, a second database that represents the electronic text message data in a message per row format,
wherein generating the conversation data by grouping the electronic messages into one or more conversations further comprises grouping, by the one or more processors, the electronic messages in the database and the plurality of electronic text messages in the second database together into one or more conversations.

3. The computer-implemented method of claim 1, wherein the grouping of the electronic messages includes:
representing each of the plurality of electronic messages as one or more features, the one or more features at least including a time frame associated with each message;
performing a clustering operation on the plurality of electronic messages based on the one or more features to identify one or more clusters of messages corresponding to one or more conversations; and
wherein the conversation data for each conversation includes the electronic messages from one of the one or more clusters of messages corresponding to each conversation.

4. The computer-implemented method of claim 1, wherein the grouping of the electronic messages into one or more conversations is further based on a time frame criteria.

5. The computer implemented method of claim 4, wherein the time frame criteria is based on inactivity time or an amount of time that has lapsed between electronic messages.

6. The computer-implemented method of claim 1, further comprising:
generating, by the one or more processors, a unique sequence value for each electronic message stored on the database based on the respective metadata associated with each electronic message.

7. The computer-implemented method of claim 6, further comprising:
determining, by the one or more processors, whether an electronic message stored on the database is a duplicate message based on the unique sequence value; and
upon determining that an electronic message is a duplicate message, removing the duplicate message from the database.

8. The computer-implemented method of claim 1, wherein the electronic message data comprises edit history information associated with each electronic message.

9. The computer-implemented method of claim 1, wherein the one or more of the conversational HTML file, the conversational text file, the CSV file associated with each user, the CSV file containing each electronic message and respective metadata associated with each electronic message, or the CSV file associated with each channel or group, are viewable and editable using standard word processing software.

10. The computer-implemented method of claim 1, wherein grouping the electronic messages into one or more conversations further includes using a trained machine learning model, wherein the trained machine learning model has been trained based on (i) training electronic message data that includes information regarding one or more electronic messages associated with the training electronic message data and (ii) training conversation data that includes a prior category for each of the one or more electronic messages, to learn relationships between the training electronic message data and the training conversation data, such that the trained machine learning model is configured to use the learned relationships to determine a respective conversation for each electronic message in response to input of the plurality of electronic messages and data related to the plurality of electronic messages.

11. A computer-implemented method for converting electronic messages into conversation data, the method comprising:
receiving, by one or more processors, and via an Application Programming Interface (API), electronic message data from an externally shared communication channel in a group-based communication platform, wherein the electronic message data comprises:
a plurality of electronic messages;
a respective user associated with each electronic message of the plurality of electronic messages;
a respective channel or group associated with each electronic message; and
a respective time or date associated with each electronic message;
receiving, by one or more processors, electronic text message data from an instant electronic text messaging application separate from the externally shared communication channel in the group-based communication platform;
generating, by the one or more processors, a database that represents the electronic message data and the electronic text message data on a database in a message per row format;
generating conversation data by grouping, by the one or more processors, using a trained machine learning model, the electronic messages and electronic text messages in the database together into one or more conversations based on the electronic message data and electronic text message data, wherein the trained machine learning model has been trained based on (i) training electronic message data and electronic text message data that includes information regarding one or more electronic messages associated with the electronic message data and one or more electronic text messages associated with the electronic text message data and (ii) training conversation data that includes a prior category for each of the one or more electronic messages and the one or more electronic text messages, to learn relationships between the training electronic message data and text message data and the training conversation data, such that the trained machine learning model is configured to use the learned relationships to determine a conversation for an electronic message or electronic text message in response to input of data related to the electronic message or electronic text message; and
outputting, by the one or more processors, the generated conversation data in a form of one or more of:
a conversational HTML file;
a text file;
a CSV file associated with each user associated with each electronic message;
a CSV file containing each electronic message and respective metadata associated with each electronic message; or
a CSV file associated with each channel or group associated with each electronic message.

12. The computer-implemented method of claim 11, wherein the electronic text message data comprises:
a plurality of electronic text messages;
a respective user associated with each electronic text message of the plurality of electronic text messages;
one or more respective recipients associated with each electronic text message; and
a respective time or date associated with each electronic text message.

13. The computer-implemented method of claim 12, wherein the grouping of the electronic messages includes:
representing each of the plurality of electronic messages as one or more features, the one or more features at least including a time frame associated with each message;
performing a clustering operation on the plurality of electronic messages based on the one or more features to identify one or more clusters of messages corresponding to one or more conversations; and
wherein the conversation data for each conversation includes the electronic messages from the corresponding cluster.

14. The computer-implemented method of claim 11, wherein the grouping of the electronic messages and electronic text messages together into one or more conversations is further comprises grouping the electronic messages and electronic text messages into one or more conversations based on a time frame criteria.

15. The computer implemented method of claim 14, wherein the time frame criteria is based on inactivity time or an amount of time that has lapsed between electronic messages and/or electronic text messages.

16. The computer-implemented method of claim 11, further comprising:
generating, by the one or more processors, a unique sequence value for each electronic message stored on the database based on the respective metadata associated with each electronic message.

17. The computer-implemented method of claim 16, further comprising:
determining, by the one or more processors, whether an electronic message stored on the database is a duplicate message based on the unique sequence value; and
upon determining that an electronic message is a duplicate message, removing the duplicate message from the database.

18. The computer-implemented method of claim 11, wherein the electronic message data comprises edit history information associated with each electronic message.

19. The computer-implemented method of claim 11, wherein the one or more of the conversational HTML file, the conversational text file, the CSV file associated with each user, the CSV file containing each electronic message and respective metadata associated with each electronic message, or the CSV file associated with each channel or group, are viewable and editable using standard word processing software.

20. A system for converting electronic messages into conversation data, the system comprising:
at least one memory storing instructions; and
at least one processor executing the instructions to perform a process including:
receiving, via an Application Programming Interface (API), electronic message data from an externally shared communication channel in a group-based communication platform, wherein the electronic message data comprises:
a plurality of electronic messages;
a respective user associated with each electronic message of the plurality of electronic messages;
a respective channel or group associated with each electronic message; and
a respective time or date associated with each electronic message;
generating a database that represents the electronic message data in a message per row format;
generating conversation data by grouping, using a trained machine learning model, the electronic messages in the database into one or more conversations based on the electronic message data, wherein the trained machine learning model is trained based on (i) training electronic message data that includes information regarding one or more electronic messages associated with the electronic message data and (ii) training conversation data that includes a prior category for each of the one or more electronic messages, to learn relationships between the training electronic message data and the training conversation data, such that the trained machine learning model is configured to use the learned relationships to determine a conversation for an electronic message in response to input of data related to the electronic message; and
outputting the generated conversation data in a form of one or more of:
a conversational HTML file;
a text file;
a CSV file associated with each user associated with each electronic message;
a CSV file containing each electronic message and respective metadata associated with each electronic message; or
a CSV file associated with each channel or group associated with each electronic message.
